(19) United States
(12) Patent Application Publication
(10) Pub. No.: US 2006/0015706 A1
(43) Pub. Date: Jan. 19, 2006

(54) TLB correlated branch predictor and method for use thereof

(76) Inventor: Chunrong Lai, Beijing (CN)

Correspondence Address: KENYON & KENYON, 1500 K STREET NW, SUITE 700, WASHINGTON, DC, 20005, US

(21) Appl. No.: 10/879,085

(22) Filed: Jun. 30, 2004

(51) Int. Cl. G06F 9/00

(52) U.S. Cl. 712/239

(57) ABSTRACT

Embodiments of the present invention relate to an apparatus and method to enable efficient branch prediction in super-scalar and other branching-enabled processors. In accordance with an embodiment of the present invention, a branch predictor may include a branch prediction circuit to predict a branch outcome in an executing instruction in a processor using an input from a translation look-aside buffer.

### FIELD OF THE INVENTION

Embodiments of the present invention relate to high-performance processors, and more specifically, to an instruction branch predictor that uses translation look-aside buffer input and a dynamic length global branch history.

### BACKGROUND

Accurate branch prediction has become more and more important to delivering on the potential performance of a super-scalar, out-of-order processor as branch instruction issue rate and instruction pipeline depths have both increased. Some prior art branch predictors are either implemented as branch predictors without a global history or as two-level branch predictors with a global history.

In some branch predictors, the global history consists of m recent branches and is implemented in an m-bit global shift register where each bit records whether or not the branch was taken. Unfortunately, the current global shift register only records a fixed-length global history. However, recent research has indicated that different instructions from different programs might experience a better prediction accuracy by using different lengths of global history.

FIG. 1 is a circuit block diagram of a branch predictor as known in the art. In FIG. 1, an m-bit history shift register 110 includes a single-bit shift input at bit m and a single-bit shift output at bit 1, with the single-bit shift input to receive an indication of whether a branch for a particular instruction was taken or not taken. For example, a “1” value is used to indicate that a branch was taken and a “0” is used to indicate that the branch was not taken. History shift register 110 is used to store a fixed-length (i.e., m-bit length) global branch prediction history, to shift out the most significant bit value, that is, the 1st bit value, and to output the entire m-bit global branch prediction history value to be stored.

In FIG. 1, history shift register 110 is coupled to an EXCLUSIVE-OR gate 120 and history shift register 110 outputs an m-bit global branch prediction history value stored in history shift register 110 to a first input of EXCLUSIVE-OR gate 120. EXCLUSIVE-OR gate 120 is also coupled to a branch addresses register 130, which outputs m-bit branch addresses to a second input of EXCLUSIVE-OR gate 120. EXCLUSIVE-OR gate 120 outputs an m-bit global history to a pattern history table 140, if the input m-bit branch address from branch addresses register 130 matches the input m-bit global history from history shift register 110. It should be noted that the m-bit branch address from branch address register 130 can be shifted, extended or cut before being output to match the number of bits output from history shift register 110. As a result, the number of bits in the m-bit branch address bit-string output from branch addresses register 130 are always matched with the bits in the input global branch prediction value from history shift register 110 even though the length of the global branch prediction history value may vary.

In FIG. 1, pattern history table 140 consists of 2^{m} entries, where each entry in the table contains a “local history.” The local history information is generally stored in a 2-bit saturated branch predictor. The output m-bit global history from EXCLUSIVE-OR gate 120 is used to select one entry from pattern history table 140, which is then used to perform the prediction. Through this design a solid prediction entry is used to store the valid history information where the different branch instructions are correlated with each other.

In FIG. 1, a 2-bit branch predictor maintains a 2-bit counter. When it is referenced it will output a branch prediction based on its content. For example, it will predict “taken” for one branch if “10” is the 2-bit content of the predictor (i.e., the pattern history table entry) assigned to that branch. Some time later the content will be updated after the real direction becomes known. For example, “10” will updated to “11,” if the branch is “taken” and updated to “01,” if the branch is “not taken.” In general, when the 2-bit counter value is greater than or equal to one half of its maximum value which is 2²⁻¹=2, the branch will be predicted to be untaken. Conversely, if the 2-bit counter value is less than 2, the branch will be predicted to be untaken. In other words, if the 2-bit counter contains either “10” (i.e., 2) or “11” (i.e. 3), the branch will be predicted to be taken and, if the 2-bit counter contains either “00” (i.e., 0) or “01” (i.e. 1), the branch will be predicted to be untaken.

While local history means a branch's output will depend on its own history, global history implies that a branch's output depends on other branch histories. In the short code example below, if the first branch outputs “taken” then the second branch will also output “taken.” Then an independent 2-bit branch predictor (the pattern history entry with global history is taken corresponding to the branch d==0) will be used to keep this information with this global history and 2-level branch prediction scheme.

| | |
|---|---|
| If(d = = 0) | // IF d = 0 |

| | |
|---|---|
| d = 1; | // THEN set d = 1 |

| | |
|---|---|
| If (d = = 1) | // IF d = 1 |

| | |
|---|---|
| ...... | // THEN continue with d = 1 conditional |

instructions

Unfortunately, since global history register 110 in FIG. 1 only records a fixed-length global history for all cases, the accuracy of the branch predictions based on the fixed-length global history is not good enough. For instance, branch predictions based on the fixed-length global history do not always accurately distinguish the previous branch instructions, which were correlated with the current branch instruction. Similarly, not only are other branch instructions, which are not correlated, also not always accurately predicted using the fixed length global history, but the correlations exist in some contexts and do not exist in other contexts where they should exist. For example, in the code example below, if the memory operand X, Y has adjacent values due to data locality. The branch predictor may perform as described above. However, this relationship will be broken with the loss of data locality.

| | |
|---|---|
| If (d = = 0) | // IF d = 0 |

| | |
|---|---|
| d = X; | // THEN set d = X |

| | |
|---|---|
| If (d = = Y) | // IF d = Y |

| | |
|---|---|
| ...... | // THEN continue with d = Y conditional |

instructions

This case shows that the global correlations sometimes rely not only on the global history or branch address but also on data locality. Loss of data locality, as shown in the above example, may occur when d is set equal to X in the second instruction, and d is determined to not equal Y in the third instruction. As a result, the d=Y conditional instructions may not be executed. This can also hurt the global history. Therefore, it is desirable to have a branch predictor that would avoid the above deficiencies.

### BRIEF DESCRIPTION OF THE DRAWINGS

FIG. 1 is a circuit block diagram of a branch predictor as known in the art.

FIG. 2 is a circuit block diagram of a translation look-aside buffer correlated branch predictor for a processor, in accordance with an embodiment of the present invention.

FIG. 3 is a flow diagram of a method according to an embodiment of the present invention.

FIG. 4 is a block diagram of a computer system, which includes one or more processors and memory, for use in accordance with an embodiment of the present invention.

### DETAILED DESCRIPTION

Embodiments of the present invention may relate to an apparatus and a method for translation look-aside buffer correlated branch prediction, which may include, but is not limited to, a global history, translation look-aside buffer correlated branch predictor and/or a two-level, translation look-aside buffer correlated branch predictor, both with and without a dynamic length branch history. For example, in accordance with an embodiment of the present invention, a processor may include a correlated branch predictor with an input wire from a translation look-aside buffer to a global branch history shift register. The input wire, which may indicate when a miss has occurred in the translation look-aside buffer, may be used to clear the global branch history shift register. Since the global branch history stored in the global branch history shift register may be trained by data-locality, clearing the global branch history shift register on a translation look-aside buffer miss may help to avoid a corrupted global branch history from non-data-locality caused by data being missing from the translation look-aside buffer.

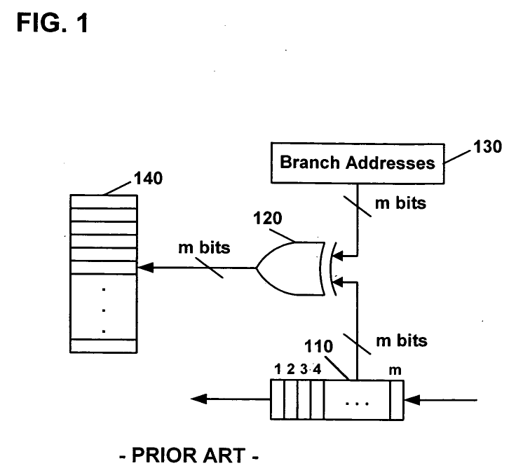

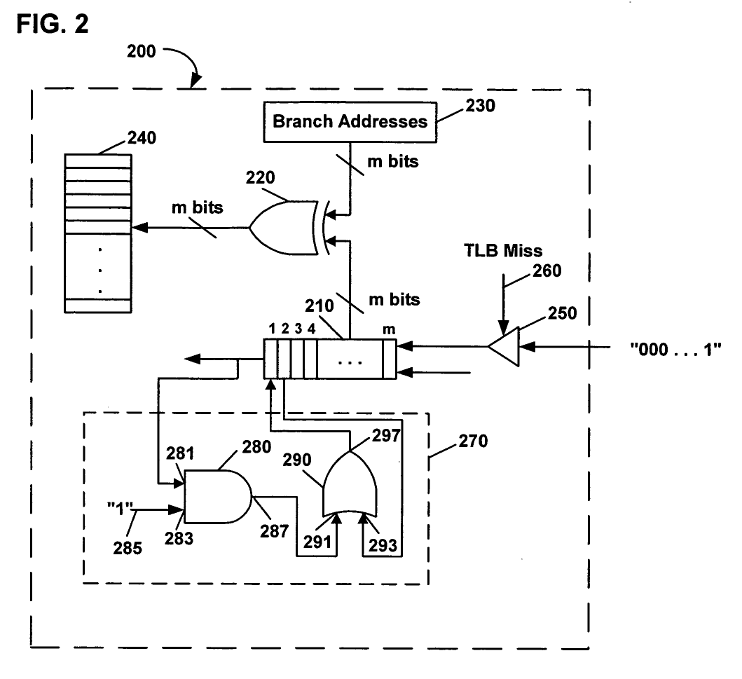

FIG. 2 is a circuit block diagram of a translation look-aside buffer correlated branch predictor for a processor, in accordance with an embodiment of the present invention. In FIG. 2, a processor 200 may include an m-bit history shift register 210, which may include a first single-bit shift input (which may be analogous to the single bit shift input in FIG. 1), a second single-bit shift input and a single-bit shift output (which may be analogous to the single bit shift input in FIG. 1), with the first single-bit shift input to receive an indication of whether a branch for a particular instruction was taken or not taken. History shift register 210 may be used to store a dynamic length global branch history for an executing instruction. In general, the most significant bit having a value of “1” may be used to identify the valid history length, for example, if the most significant “1” is in the 5^{th} bit of an m-bit shift register, the global history may be determined to be m−5 bits long. As a result, the most significant “1” value does not indicate whether or not a branch occurred. In accordance with an embodiment of the present invention, a “1” value may be used as the enable signal to indicate that a branch was taken and a “0” may be used as a non-enable signal to indicate that the branch was not taken. History shift register 210 may be used to store a dynamic-length global branch prediction history having a maximum length of m−1 bits, and to output the most significant bit value, that is, the m−1 bit value. Therefore, a “0000 . . . 01” string may indicate a global history of length zero, which may indicate that the global history was recently flushed from history shift register 210. Similarly, in accordance with an embodiment of the present invention, a “0000 . . . 00” string may be taken to be meaningless, since it may indicate a non-existent global history length, and a “1X . . . Y” string (where X and Y may each equal “0” or “1”) may be taken to contain the longest possible global history length that the register may contain, namely, a length of m−1 bits.

In FIG. 2, history shift register 210 may be coupled to an EXCLUSIVE-OR gate 220 and history shift register 210 may output an m-bit global branch prediction history value stored in history shift register 210 to a first input of EXCLUSIVE-OR gate 220. EXCLUSIVE-OR gate 220 also may be coupled to a branch addresses register 230, which may output m-bit branch addresses to a second input of EXCLUSIVE-OR gate 220. EXCLUSIVE-OR gate 220 may output an m-bit global history to a pattern history table 240, if the input m-bit branch address from branch addresses register 230 matches the input m-bit global history from history shift register 210. It should be noted that the m-bit branch address from branch address register 230 may be shifted, extended or cut before being output to match the number of bits output from history shift register 210. As a result, the number of bits in the m-bit branch address bit-string output from branch addresses register 230, generally, are always matched with the bits in the input global branch prediction value from history shift register 210 even though the length of the global branch prediction history value may vary.

In FIG. 2, pattern history table 240 may consist of 2^{m} entries, where each entry in the table may contain a “local history.” The local history information, generally, may be stored in a 2-bit saturated branch predictor. The output m-bit global history from EXCLUSIVE-OR gate 220 may be used to select one entry from pattern history table 240, which may be used to perform the prediction. Through this design a solid prediction entry may be used to store the valid history information where the different branch instructions are correlated with each other.

In general, in FIG. 2, history shift register 210 may shift as described in FIG. 1, with two exceptions, namely, when the global branch history is to be flushed and when the global history string value equals “1XYZ . . . ,” where X, Y, and Z may each equal “0” or “1”. First, in FIG. 2, if history shift register 210 is to be flushed, the global branch history string in history shift register 210 may be cleared and set equal to “0000 . . . 01”. Second, when history shift register 210 contains an m−1 bit long global branch history, which means a “1” may be stored in the most significant bit (i.e., bit 1) of history shift register 210, the “1” value stored in bit 1 may be maintained and the bit value in bit 2 may be shifted out

History shift register 210 may also be coupled to a latched memory 250, for example, a three-state buffer, which may receive a signal from a translation look-aside buffer (“TLB”) (not shown) indicating whether there has been a miss in the TLB and latched memory 250 may also receive and store an m-bit input clear value. The m-bit input clear value may include all “0's,” except for the right-most digit, which may be a “1,” for example, where m=16, a 16-bit input clear value may equal “0000000000000001.” When a TLB miss occurs, an enable signal indicating a TLB miss occurred may be asserted by the TLB (not shown) on a TLB miss line 260. When the enable signal indicating a TLB miss occurred reaches latched memory 250, the m-bit input clear value stored in latched memory 250 may be read into history shift register 210. As a result, history shift register 210 may be “cleared,” so that, the m-bit value currently stored in history shift register 210 may be overwritten by an m-bit value, for example, “0000000000000001,” from latched memory 250.

In FIG. 2, a feedback circuit 270 may be coupled to a bit 1 position and a bit 2 position in history shift register 210. Feedback circuit 270 may include an AND gate 280 coupled to history shift register 210 to receive the output most significant bit and coupled to an OR gate 290, which may be coupled to the bit 1 and bit 2 positions of history shift register 210. Feedback circuit 270 may be used to maintain a most significant bit value of 1 in the m−1 bit position in history shift register 210. Specifically, a first input 281 of AND gate 280 may be coupled to the output of history shift register 210. A second input 283 of AND gate 280 may receive a “1” value, which may be ANDed with a value of the output of history shift register 210 to result in an AND value being output from AND gate 280 via an output 287 to a first input 291 of OR gate 290. A second input 293 of OR gate 290 may be coupled to and receive a value from the bit 2 position in history shift register 210. An output 297 of OR gate 290 may be coupled to and output an OR value to the bit 1 position in history shift register 210. Since second input 283 of AND gate 280 has a set input of “1”, only two input combinations may be possible, namely, (0,1) and (1,1). Regardless, only two output values may be possible from AND gate 280. That is, a “1” may be output from AND gate 280 if the output value of the m−1 bit position in history shift register 210 is also “1”, and a “0” may be output from AND gate 280 if the output value of the m−1 bit position in history shift register 210 is a “0”. Similarly, although OR gate 290 may also only have the same two possible output values (i.e., “0” or “1”), the results may occur from four possible input combinations, namely, (0,0), (0,1), (1,0) and (1,1), since neither first input 291 or second input 293 to OR gate 290 are limited to a single value. As seen in Table 1, logic OR table, a “1” may be output as a result of three of the four possible input value combinations. Therefore, since AND gate 280 will always output a “1” when the bit 1 value in history shift register 210 is “1,” it may be seen that feedback circuit 270 will maintain the “1” value in the bit 1 position until history shift register 210 may be cleared by a TLB miss.

TABLE 1

| | AND Gate Output | | |
|---|---|---|---|
| Bit 2 Output | | 1 | 0 |
| | 1 | 1 | 1 |
| | 0 | 1 | 0 |

Embodiments of the present invention may be implemented in an out-of-order processor in which a fetch/decode unit may fetch instructions, for example, macro-instructions, from a storage location, for example, an instruction cache, and may decode the instructions. For a Complex Instruction Set Computer (“CISC”) architecture, the fetch/decode unit may decode a complex instruction into one or more micro-instructions/operations. Usually, these micro-instructions define a load-store type architecture, so that micro-instructions involving memory operations may be practiced for other architectures, such as Reduced Instruction Set Computer (“RISC”) or Very Large Instruction Word (“VLIW”) architectures.

In a typical RISC architecture, instructions are not decoded into micro-instructions. Because the present invention may be practiced for RISC architectures as well as CISC architectures, no distinction is made between instructions and micro-instructions/operations unless otherwise stated, and simply refer to these as instructions.

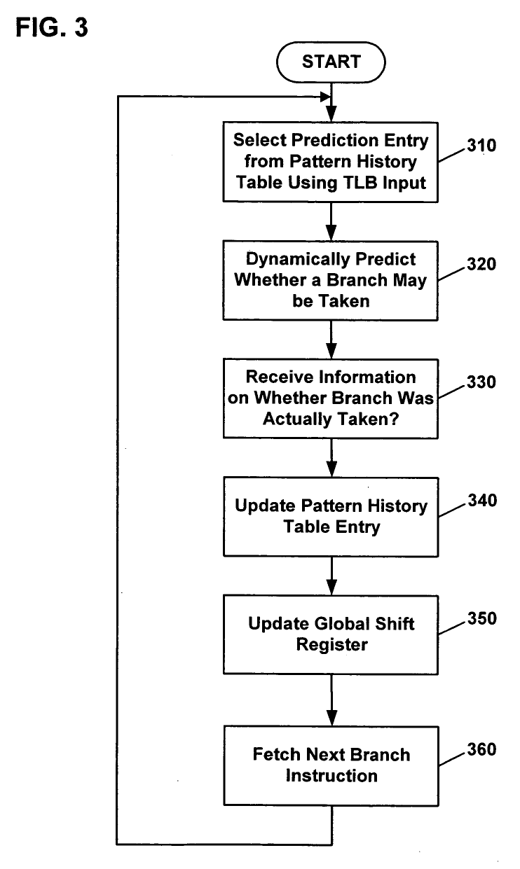

FIG. 3 is a flow diagram of a method according to an embodiment of the present invention. In FIG. 3, a prediction entry may be selected (310) from, for example, pattern history table 240, using an input from the TLB and whether a branch may be taken based on the selected prediction entry and the TLB input may be dynamically predicted (320). The method may receive (330) information on whether the branch was actually taken, and the prediction entry may be updated (340), for example, updated (340) in pattern history table 240, based on whether or not the branch was actually taken. A global history value that indicates whether a branch was actually taken and pattern history table 240 may be updated (350), for example, in history shift register 210 based on whether the branch was actually taken; and a next branch instruction may be fetched (360). In general, the method terminates only when the processor is turned off or no additional processing of instructions is to be performed.

In an alternative embodiment of the present invention, although not explicitly shown, the method in FIG. 3 may terminate and wait for more branch instructions, if additional branch instructions are not immediately available.

While the method in FIG. 3 may imply a specific order for performing the method, it should not be taken to limit embodiments of the present invention to such an order. In fact, embodiments of the present invention are contemplated in which some or all of the elements in the method may be performed in any order including, but not limited to, being performed totally or partially in parallel, for example, in an out-of-order (“OOO”) processor. Similarly, although for ease of illustration, the method in FIG. 3 has been simplified to reflect processing one branch at a time, embodiments of the present invention are contemplated in which multiple branches may be processed simultaneously, limited of course by any existing data dependencies.

The following simplified pseudo-code section illustrates the operation of an implementation of a TLB correlated global history branch predictor, in accordance with an embodiment of the present invention.

check_and_initialize_predictor(argc, argv, &inTrace, &aPredictor);
while (!inTrace−>EndOfTrace( )){

aPredictor−>SelectPredictionEntry(inTrace−>GetAddress( ), inTrace−>TLBMissOrNot( ));

// TLB information here

bool pr-taken = aPredictor−>prediction(inTrace−>ForwardBranchOrNot( )); // enable

static prediction

aPredictor−>UpdatePredictor(inTrace−>TakenOrNot( ),pr_taken); // update pattern history

table and shift global register after know real target of branch

inTrace−>read_trace( ); // read next branch instruction in the simulation

}
aPredictor−>ShowAccuracy( );

For example, in the above pseudo-code, the predictor may be seen to operate during execution of an instruction to predict outcomes of each branch in the instruction and update the prediction with the actual target after it is known. Although the above pseudo-code example may imply serial execution, it is merely illustrative of the overall concept and alternate embodiments are contemplated in which parallel and/or out of order execution of the branches may occur dependent, of course, on any inter-bound data dependencies.

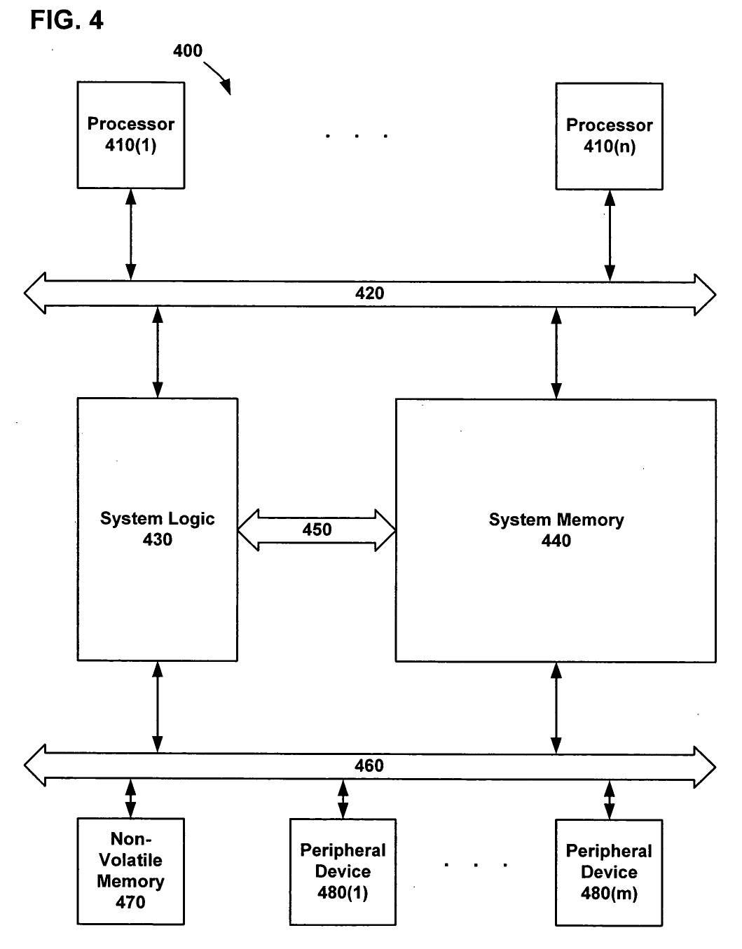

FIG. 4 is a block diagram of a computer system, which may include one or more processors and memory, for use in accordance with an embodiment of the present invention. In FIG. 4, a computer system 400 may include one or more processors 410(1)-410(n) coupled to a processor bus 420, which may be coupled to a system logic 430. Each of the one or more processors 410(1)-410(n) may be an N-bit processor and may include a decoder (not shown) and one or more N-bit registers (not shown). System logic 430 may be coupled to a system memory 440 through a bus 450 and coupled to a non-volatile memory 470 and one or more peripheral devices 480(1)-480(m) through a peripheral bus 460. Peripheral bus 460 may represent, for example, one or more Peripheral Component Interconnect (PCI) buses, PCI Special Interest Group (SIG) PCI Local Bus Specification, Revision 2.2., published Dec. 18, 1998; industry standard architecture (ISA) buses; Extended ISA (EISA) buses, BCPR Services Inc. EISA Specification, Version 3.12, 1992, published 1992; universal serial bus (USB), USB Specification, Version 1.1, published Sep. 23, 1998; and comparable peripherable buses. Non-volatile memory 470 may be a static memory device such as a read only memory (ROM) or a flash memory. Peripheral devices 480(1)-480(m) may include, for example, a keyboard; a mouse or other pointing devices; mass storage devices such as hard disk drives, compact disc (CD) drives, optical disks, and digital video disc (DVD) drives; diplays and the like.

Although the present invention has been disclosed in detail, it should be understood that various changes, substitutions, and alterations may be made herein. Moreover, although software and hardware are described to control certain functions, such functions can be performed using either software, hardware or a combination of software and hardware, as is well known in the art. Likewise, in the claims below, the term “instruction” may encompass an instruction in a RISC architecture or an instruction in a CISC architecture, as well as instructions used in other computer architectures. Other examples are readily ascertainable by one skilled in the art and may be made without departing from the spirit and scope of the present invention as defined by the following claims.

What is claimed is:

1. A branch predictor comprising:
a branch prediction circuit to predict a branch outcome in an executing instruction in a processor using an input from a translation look-aside buffer.

2. The branch predictor of claim 1 wherein the branch prediction circuit comprises:
a pattern history table; and
a history shift register coupled to the pattern history table and to the translation look-aside buffer, the history shift register to clear itself upon receipt of a miss signal from the translation look-aside buffer.

3. The branch predictor of claim 2 wherein the branch prediction circuit further comprises:
a memory coupled to the history shift register, the memory to pass a reset value to the history shift register upon receipt of the miss signal from the translation look-aside buffer.

4. The branch predictor of claim 3 wherein the memory comprises:
a three-state buffer.

5. The branch predictor of claim 3 wherein the branch prediction circuit further comprises:
a feedback loop coupled to the history shift register, the feedback loop to maintain a most significant bit value in the history shift register.

6. The branch predictor of claim 5 wherein the feedback loop to maintain the most significant bit value to be a 1.

7. The branch predictor of claim 5 wherein a bit position of a most significant 1 value in the history shift register to determine a length of a global branch history stored in the history shift register.

8. The branch predictor of claim 7 wherein the length of the global branch history stored in the history shift register is defined by the bit position of the most significant 1 value.

9. The branch predictor of claim 5 wherein the feedback loop comprises:
an AND gate coupled to the history shift register to receive an output bit value of the history shift register and an enable signal; and
an OR gate coupled to the AND gate and the history shift register, the OR gate to receive a first input value from the AND gate and a second input value from the history shift register and output a new bit value to the history shift register.

10. The branch predictor of claim 2 wherein the history shift register to contain a dynamic length global branch history.

11. The branch predictor of claim 2 wherein the history shift register to include m-bits and to output an m-bit pattern history value to the pattern history table via an EXCLUSIVE-OR gate.

12. The branch predictor of claim 11 wherein the EXCLUSIVE-OR gate to receive the m-bit pattern history value and an m-bit branch address value and to output an m-bit pattern history value to the pattern history table.

13. A branch predictor comprising:
a branch prediction circuit including an m-bit global branch history;
a memory coupled to a translation look-aside buffer and to the branch prediction circuit, the memory to reset the branch prediction circuit upon receipt of an indication of a miss in the translation look-aside buffer; and
a feedback loop coupled to the branch prediction circuit, the feedback loop to maintain a most significant bit value in the branch prediction circuit when a length of the global branch history equals m−1.

14. The branch predictor of claim 13 wherein the branch prediction circuit comprises:
a pattern history table;
a history shift register coupled to the pattern history table and to the translation look-aside buffer, the history shift register to clear itself upon receipt of the indication of the miss from the translation look-aside buffer; and
a branch addresses memory to store addresses for each branch indicated in the history shift register.

15. The branch predictor of claim 14 wherein the memory is coupled to the history shift register.

16. The branch predictor of claim 13 wherein the memory comprises:
a three-state buffer.

17. The branch predictor of claim 13 wherein the feedback loop comprises:
an AND gate coupled to the history shift register to receive an output bit value of the history shift register and an enable signal; and
an OR gate coupled to the AND gate and the history shift register, the OR gate to receive a first input value from the AND gate and a second input value from the history shift register and output a new bit value to the history shift register.

18. A processor comprising:
a translation look-aside buffer;
a branch prediction circuit including an m-bit global branch history;
a memory coupled to the translation look-aside buffer and to the branch prediction circuit, the memory to reset the branch prediction circuit upon receipt of an indication of a miss in the translation look-aside buffer; and
a feedback loop coupled to the branch prediction circuit, the feedback loop to maintain a most significant bit value in the branch prediction circuit when a length of the global branch history equals m−1.

19. The processor of claim 18 wherein the branch prediction circuit comprises:
a pattern history table;
a history shift register coupled to the pattern history table and to the translation look-aside buffer, the history shift register to clear itself upon receipt of the indication of the miss from the translation look-aside buffer; and
a branch addresses memory to store addresses for each branch indicated in the history shift register.

20. The processor of claim 19 wherein the memory is coupled to the history shift register.

21. The processor of claim 18 wherein the memory comprises:
a three-state buffer.

22. The processor of claim 18 wherein the feedback loop comprises:
an AND gate coupled to the history shift register to receive an output bit value of the history shift register and an enable signal; and
an OR gate coupled to the AND gate and the history shift register, the OR gate to receive a first input value from the AND gate and a second input value from the history shift register and output a new bit value to the history shift register.

23. A computing system comprising:
a memory;
a processor coupled to the memory, the processor including
a translation look-aside buffer;
a branch prediction circuit having an m-bit global branch history;
a memory coupled to the translation look-aside buffer and to the branch prediction circuit, the memory to reset the branch prediction circuit upon receipt of an indication of a miss in the translation look-aside buffer; and
a feedback loop coupled to the branch prediction circuit, the feedback loop to maintain a most significant bit value in the branch prediction circuit when a length of the global branch history equals m−1.

24. The computing system of claim 23 wherein the branch prediction circuit comprises:
a pattern history table;
a history shift register coupled to the pattern history table and to the translation look-aside buffer, the history shift register to clear itself upon receipt of the indication of the miss from the translation look-aside buffer; and
a branch addresses memory to store addresses for each branch indicated in the history shift register.

25. The computing system of claim 24 wherein the memory is coupled to the history shift register.

26. A method comprising:
predicting a branch outcome of a plurality of executing instructions in a processor using an input from a translation look-aside buffer.

27. The method of claim 26 wherein the predicting a branch outcome of a plurality of executing instructions in a processor using an input from a translation look-aside buffer comprises:
predicting the branch outcome for each of the plurality of executing instructions;
maintaining the predicted branch outcome for each of the plurality of executing instructions; and
clearing the global branch history upon receipt of an indication that a miss occurred in a translation look-aside buffer for data associated with one of the plurality of executing instructions.

28. The method of claim 27 wherein clearing the global branch history upon receipt of an indication that a miss occurred in a translation look-aside buffer comprises:
replacing the global branch history with a predetermined clear-value.

29. A machine-readable medium having stored thereon executable instructions for performing a method comprising:
predicting a branch outcome of a plurality of executing instructions in a processor using an input from a translation look-aside buffer.

30. The machine-readable medium of claim 29 wherein the predicting a branch outcome of a plurality of executing instructions in a processor using an input from a translation look-aside buffer comprises:
predicting the branch outcome for each of the plurality of executing instructions;
maintaining the predicted branch outcome for each of the plurality of executing instructions; and
clearing the global branch history upon receipt of an indication that a miss occurred in a translation look-aside buffer for data associated with one of the plurality of executing instructions.

31. The machine-readable medium of claim 30 wherein clearing the global branch history upon receipt of an indication that a miss occurred in a translation look-aside buffer comprises:
replacing the global branch history with a predetermined clear-value.

32. A method comprising:
selecting a prediction entry using an input from a translation look-aside buffer;
predicting whether a branch will be taken based on the prediction entry and the input;
receiving information on whether the branch was actually taken;
updating the prediction entry with the information on whether the branch was actually taken;
updating a global history value to indicate whether the branch was actually taken; and fetching a next branch instruction.

33. The method of claim 32 wherein the selecting a prediction entry using an input from a translation look-aside buffer comprises:
selecting a prediction entry from a pattern history table using the input from the translation look-aside buffer.

34. The method of claim 32 wherein updating the prediction entry comprises: updating the prediction entry in a pattern history table.

35. The method of claim 32 wherein updating a global history value to indicate whether the branch was actually taken comprises:
updating the global history value in a global shift register to indicate whether the branch was actually taken.

36. A machine-readable medium having stored thereon executable instructions for performing a method of comprising:
selecting a prediction entry using an input from a translation look-aside buffer;
predicting whether a branch will be taken based on the prediction entry and the input;
receiving information on whether the branch was actually taken;
updating the prediction entry with the information on whether the branch was actually taken;
updating a global history value to indicate whether the branch was actually taken; and
fetching a next branch instruction.

37. The machine-readable medium of claim 36 wherein the selecting a prediction entry using an input from a translation look-aside buffer comprises:
selecting the prediction entry from a pattern history table using the input from the translation look-aside buffer.
updating a global history value to indicate whether the branch was actually taken; and
fetching a next branch instruction.

38. The machine-readable medium of claim 36 wherein updating the prediction entry comprises:
updating the prediction entry from the pattern history table.

39. The machine-readable medium of claim 36 wherein updating a global history value to indicate whether the branch was actually taken comprises:
updating the global history value in a global shift register to indicate whether the branch was actually taken.
